(19) United States
(12) Patent Application Publication
(10) Pub. No.: US 2021/0183279 A1
(43) Pub. Date: Jun. 17, 2021

(54) SIGNAGE MOUNTING SYSTEM

(71) Applicant: Everbrite, LLC, Greenfield, WI (US)

(72) Inventors: Steve Walczak, JR., Franksville, WI (US); Joshua Stangel, Milwaukee, WI (US)

(21) Appl. No.: 17/122,157

(22) Filed: Dec. 15, 2020

Related U.S. Application Data
(60) Provisional application No. 62/948,554, filed on Dec. 16, 2019.

(51) Int. Cl. G09F 13/22; G09F 7/18

(52) U.S. Cl. CPC G09F 13/22; G09F 7/18; G09F 2007/1873; G09F 2007/1843; G09F 2013/222

(57) ABSTRACT

A sign assembly including a raceway, a plate removably coupled to the raceway, and a sign coupled to the plate such that the sign and the plate are removable together from the raceway. An electrical connection extends through the plate to the sign.

### CROSS-REFERENCE TO RELATED APPLICATIONS

This application claims priority to co-pending U.S. Provisional Patent Application No. 62/948,554 filed on Dec. 16, 2019, the entire contents of which are incorporated herein by reference.

### FIELD

The present disclosure relates to a mounting system for signage. More specifically, the disclosure relates to a mounting system for illuminated signage.

### BACKGROUND

Conventional mounting systems for signage include raceways that are complex to manufacture and cannot be easily interchanged with different signs. For example, conventional raceways define a complete enclosure that is formed by sheet metal fabrication, including cutting, bending, and punching. The process is labor intensive, requires specialized metal fabrication equipment (e.g., turret punches/presses, press brakes, laser cutting machines, etc.), and necessitates skilled sheet metal operators to operate the specialized metal fabrication equipment. As such, to produce complex raceway shapes is time intensive and cost prohibitive. Furthermore, once a sign has been attached to a conventional raceway, it is difficult and inconvenient for a user to change, adjust, or service the sign.

### SUMMARY

Described herein is a mounting system for illuminated signage that provides a uniform mounting surface for signage, encloses electrical wiring and associate components, and simplifies fabrication and mounting.

In one aspect, this disclosure provides a sign assembly including a raceway, a plate removably coupled to the raceway, and a sign coupled to the plate such that the sign and the plate are removable together from the raceway. An electrical connection extends through the plate to the sign.

In another aspect, this disclosure provides a sign assembly including a body defining a channel and an opening, and a plate removably coupled to the body. The plate at least partially blocks the opening when the plate is coupled to the body. The sign assembly further includes a sign coupled to the plate such that the sign and the plate are removable together from the body.

In another aspect, this disclosure provides a raceway configured to mount to a surface. The raceway includes a rear portion, a top portion extending from the rear portion, a bottom portion extending from the rear portion, a first front portion extending from the top portion, and a second front portion extending from the bottom portion. The raceway further includes an opening positioned between the first front portion and second front portion, a ledge extending from the bottom portion, and a groove coupled to the top portion. The groove is positioned opposite the ledge and the opening is positioned between the groove and the ledge.

Other aspects of this disclosure will become apparent by consideration of the detailed description and accompanying drawings.

### BRIEF DESCRIPTION OF THE DRAWINGS

FIG. 1 is a perspective view of an illuminated sign assembly.

FIG. 2 is a rear perspective view of the illuminated sign assembly of FIG. 1.

FIG. 3 is a front perspective view of the illuminated sign assembly of FIG. 1, with illuminated letters removed.

FIG. 4 is a cross-sectional view of the illuminated sign assembly of FIG. 1, taken along lines 4-4 shown in FIG. 2.

FIG. 5 is a partial exploded view of the illuminated sign assembly of FIG. 1.

FIG. 6 is a perspective view of a raceway of the illuminated sign assembly of FIG. 1.

FIG. 7 is a cross-sectional view of the raceway of FIG. 6, taken along lines 7-7 shown in FIG. 6.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

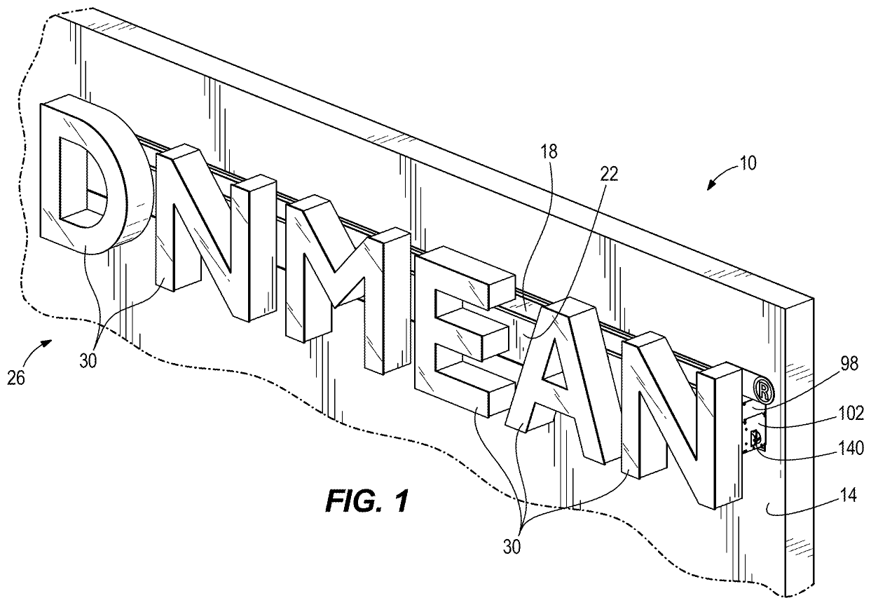

With reference to FIG. 1, a sign assembly 10 is illustrated attached and mounted to a surface 14. More specifically, the sign assembly 10 is shown mounted to a vertical wall. In other embodiments, the sign assembly 10 is mounted to any suitable desired location (e.g., a building, interior wall, exterior wall, a post, a pole, or other suitable location for displaying a sign). The sign assembly 10 includes a raceway 18 (i.e., a main body), a face plate 22 removably coupled to the raceway 18, and a sign 26 coupled to the face plate 22. For purposes of this disclosure, the sign 26 is illustrated as including individual letters 30 (i.e., channel letters). It should be appreciated that the individual letters shown (“DNMEAN”) is for purposes of illustration and is in no way limiting. Alternatively or additionally, the sign 26 can include any indicia including a logo, a trademark, branding, messaging, or any other suitable information to provide visual identification of an associated product or service, or to communicate a message. In some embodiments, the sign 26 is electrically powered. In some embodiments, the sign 26 is illuminated.

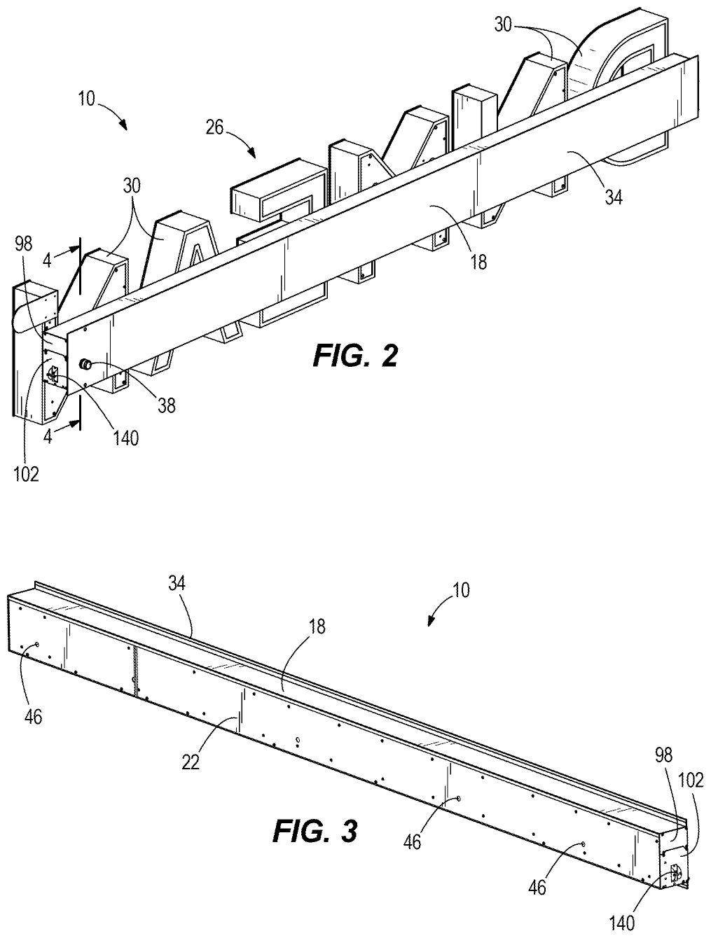

With reference to FIG. 2, the sign assembly 10 is illustrated removed from the mount surface 14. The raceway 18 includes a rear wall portion 34 that is configured to be attached to the mount surface 14. In the illustrated embodiment, an electrical inlet 38 is positioned on the rear wall portion 34. An electrical power source (e.g., a conventional 120V or 240V AC power source) is coupled to the sign assembly 10, with electrical power entering the sign assembly 10 through the electrical inlet 38 in the rear wall portion 34.

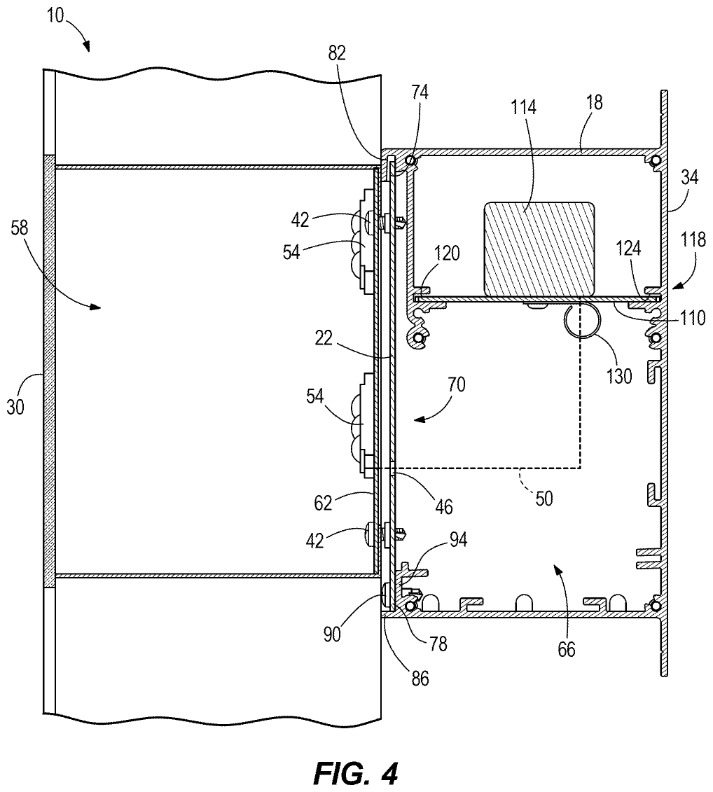

The sign 26 is coupled to the face plate 22 by fasteners or the like. In the illustrated embodiment, the individual letters 30 are secured to the face plate 22 by fasteners 42 (FIG. 4). As explained in greater detail herein, the face plate 22 and the corresponding sign 26 are easily attached or removed from the raceway 18 without removing the raceway 18 from the mount surface 14. In this way, the sign 26 can be easily interchanged for a different sign coupled to the raceway 18. This improves the overall flexibility and serviceability of the sign assembly 10. For example, if the sign needs to be changed to a different sign, the entire sign assembly 10 does not need to be replace or removed from the mount surface 14. In particular, the raceway 18 remains secured to the mount surface 14 while only the face plate 22 and corresponding sign 26 are replaced.

With reference to FIG. 3, the sign assembly 10 is illustrated with the letters 30 removed for clarity. The face plate 22 includes an aperture 46 that extends through the face plate 22. In the illustrated embodiment, the face plate 22 includes a plurality of apertures 46. The apertures 46 permits an electrical connection 50 (e.g., a wire harness, an electrical cable, etc.) to extend through the face plate 22 to reach the letters 30 (FIG. 4). In other words, the electrical connection 50 extends through one of the apertures 46 to provide electrical power to a corresponding sign letter 30.

With reference to FIG. 4, a cross-section through the sign assembly 10 is illustrated. The letters 30 include light emitting diodes 54 positioned within a cavity 58 of the letter 30. In the illustrated embodiment, the light emitting diodes 54 are mounted to an interior wall 62 of the letter 30 and powered by the electrical connection 50. The raceway 18 forms a channel with an interior chamber 66 and an opening 70 (i.e., an elongated gap). In the illustrate embodiment, the opening 70 in the raceway 18 is forward-facing, opposite the rear wall portion 34. As illustrated in FIG. 4, the electrical connection 50 is at least partially positioned within the chamber 66 and passes through the opening 70 in the raceway 18. Therefore, the raceway 18 does not require any additional apertures to be drilled or otherwise formed in order to electrically connect the sign 26.

With continued reference to FIG. 4, the face plate 22 is removably coupled to the raceway 18. The face plate 22 includes a first end 74 and a second end 78 opposite the first end 74. The first end 74 of the face plate 22 is received within a groove 82 on the raceway 18. The second end 78 of the face plate 22 is seated on a ledge 86 on the raceway 18. In the illustrated embodiment, the groove 82 is positioned opposite the ledge 86, and the opening 70 is positioned between the groove 82 and the ledge 86. A fastener 90 secures the face plate 22 to the raceway 18. Specifically, the fastener 90 secures the second end 78 to a wall portion 94 on the raceway 18. Without the fasteners 90 the face plate 22 is movable and slidable with respect to the raceway 18. With the second end 78 secured to the raceway 18, the first end 74 of the face plate 22 is trapped within the groove 82. Therefore, fasteners are not necessary to secure the first end 74 to the raceway 18. As such, the number of fasteners required to secure the face plate 22 to the raceway 18 is advantageously reduced; decreasing the time require to assemble the sign assembly 10. When the face plate 22 is attached to the raceway 18, the face plate 22 at least partially blocks the opening 70. In other words, the face plate 22 covers at least a portion of the opening 70 on the front of the raceway 18.

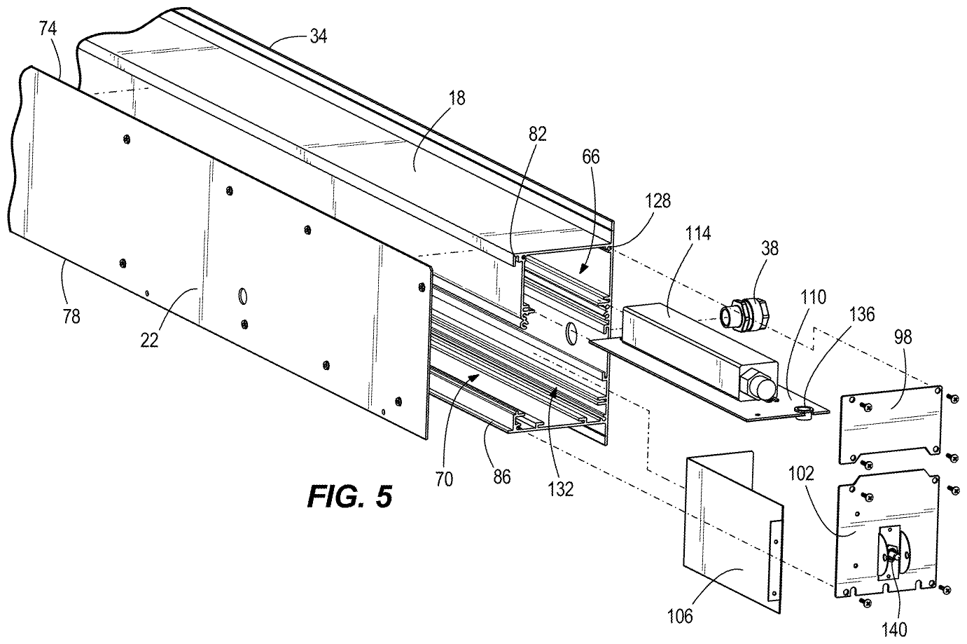

With reference to FIG. 5, the sign assembly 10 is illustrated with the face plate 22, the electrical inlet 38, a first cover 98, a second cover 102, a divider 106, a tray 110, and an electrical driver 114 (i.e., a power supply) exploded off from and out of the raceway 18.

With reference to FIG. 4, the tray 110 is supported within the interior chamber 66 of the raceway 18 by a rail 118 on the raceway 18. In the illustrated embodiment, the rail 118 includes a first groove 120 and a second groove 124 opposite the first groove 120. The tray 110 is slidable with respect to the rail 118 and the tray 110 is at least partially received within both the first groove 120 and the second groove 124. The tray 110 supports the electrical driver 114 within the raceway 18. Specifically, the electrical driver 114 is in physical contact with the tray 110 and the electrical driver 114 does not directly contact the raceway 18. In other embodiments, the tray 110 may support any electrical component (e.g., a driver, a circuit board, a wire, etc.). In other embodiments, the sign assembly 10 may include a plurality of trays 110 that are similarly slidable relative to a plurality of rails 118 in the raceway 18. For example, in some embodiments a tray is provide in the bottom of the raceway 18 to keep any electrical component from contacting the bottom surface of the raceway 18.

When assembled, the first cover 98 and the second cover 102 are attached to an axial end 128 of the raceway 18. The first cover 98 partially encloses the electrical driver 114 within the interior chamber 66 of the raceway 18. As such, removal of the first cover 98 from the raceway 18 provides easy access to the electrical driver 114. In some embodiments, the electrical driver 114 is a light emitting diode (LED) driver designed to provide current to the lights associated with the sign 26. For example, the electrical driver 114 can rectify higher voltage, alternating current to low voltage, direct current suitable for the light emitting diodes 54. The electrical driver 114 may be referred to more generally as a “power supply.” In other embodiments, the electrical driver 114 may be replaced with a ballast for a fluorescent light, for example, in which case the “power supply” would refer to the ballast. In other words, the term “power supply” encompasses the electrical driver 114, a ballast, a transformer, or other suitable components that supply electrical power.

In the illustrated embodiment, the electrical connection 50 (FIG. 4) is made between the electrical driver 114 and the light emitting diodes 54. The electrical driver 114 also protects from voltage or current fluctuations. In other embodiments, the electrical driver 114 is any suitable driver for facilitating proper operation of the lights or other electronic components associated with the sign. A wire guide 130 at least partially supports the electrical connection 50. In the illustrated embodiment, the wire guide 130 is coupled to the raceway 18 and extends into the chamber 66.

Like the first cover 98, the second cover 102 partially encloses a portion of the electrical inlet 38. In the illustrated embodiment, the divider 106 is received within the raceway 18 and at least partially forms a high voltage chamber 132. In the illustrated embodiment, the high voltage chamber 132 is enclosed by the raceway 18, the divider 106, the face plate 22, the tray 110, and the second cover 102. The electrical inlet 38 is at least partially within the high voltage chamber 132. An aperture 136 is provided in the tray 110 to permit electrical connections between the electric power source in the high voltage chamber 132 and the electrical driver 114. The second cover 102 includes a user-activated switch 140 that is accessible from the exterior of the sign assembly 10. In some embodiments, the switch 140 is a main power on/off switch that controls, for example, illumination of the sign 26. As such, the high voltage input to the sign assembly 10 through the electrical inlet 38 is safely isolated within the high voltage chamber 132. In some embodiments, the divider 106 is be omitted.

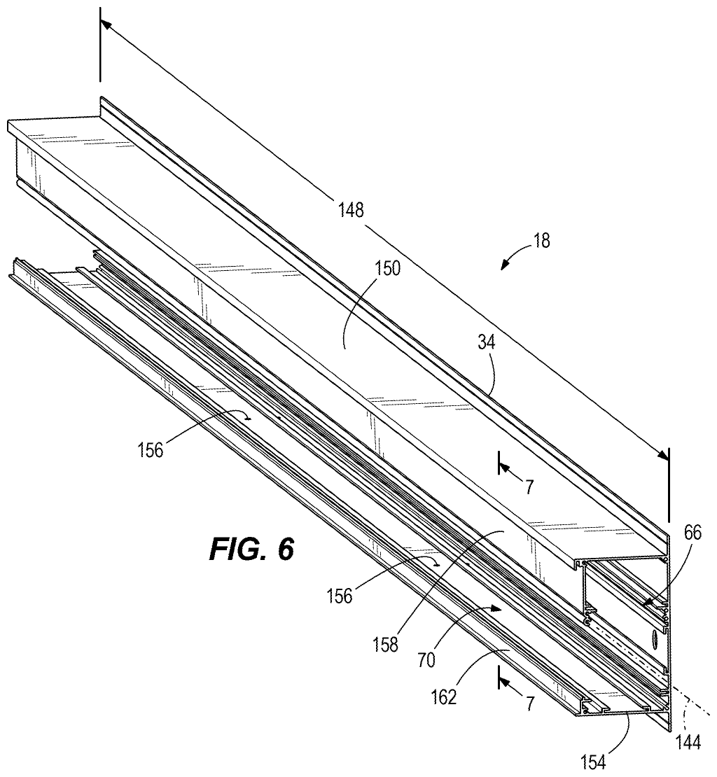

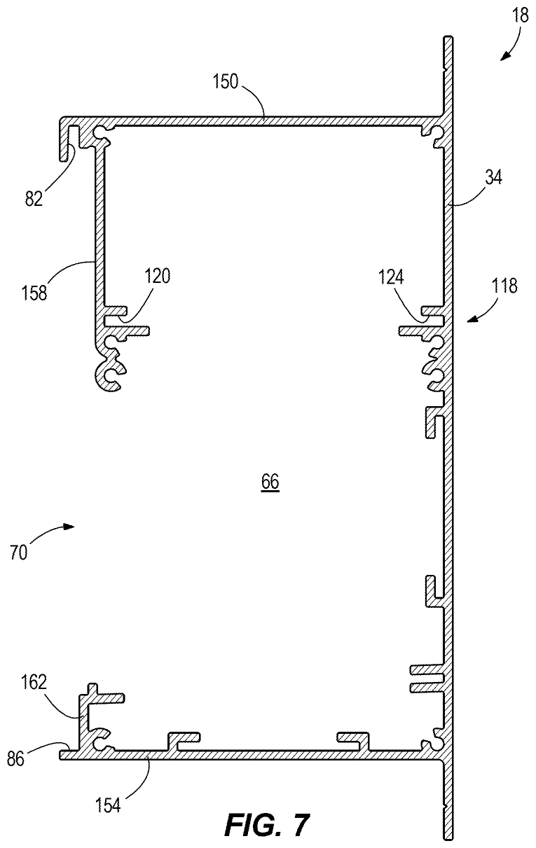

With reference to FIGS. 6 and 7, the raceway 18 is illustrated in more detail. The raceway 18 extends along a longitudinal axis 144 and defines a length 148 that extends between the axial ends 128. The raceway 18 is a unitary body that is an extruded material. In the illustrated embodiment, the raceway 18 is extruded and formed of metal, and more specifically aluminum. The aluminum extrusion of the raceway 18 advantageously eliminates the need for forming or press brake operations required to manufacture conventional raceways. In other embodiments, the raceway may be formed of any suitable metal, plastic, metal alloy, or other suitable material (e.g., steel, polyvinyl chloride, polypropylene, low-density polyethylene, etc.).

With reference to FIG. 7, the body of the raceway 18 includes the rear wall portion 34, a top wall portion 150 extending from the rear wall portion 34, and a bottom wall portion 154 extending from the rear wall portion 34. The rear wall portion 34 is the surface of the raceway 18 configured to be mounted to the desired location (e.g., a wall, a pole, a building, etc.). In the illustrated embodiment, the top wall portion 150 and the bottom wall portion 154 are parallel to each other. In addition, in the illustrated embodiment the top and bottom wall portions 150, 154 extend perpendicular from the rear wall portion 34. The rear wall portion 34 extends beyond the top and bottom wall portions 150, 154. Drain holes 156 are formed in the bottom wall portion 154 to allow any liquid (e.g., rain water) to drain out of the raceway 18.

With continued reference to FIG. 7, the raceway 18 includes a first front wall portion 158 extending from the top wall portion 150 and a second front wall portion 162 extending from the bottom wall portion 154. The opening 70 is positioned between the first front wall portion 158 and the second front wall portion 162. In other words, the opening 70 to the interior chamber 66 of the raceway 18 is formed in the front of the raceway 18 (i.e., the side of the raceway 18 that supports the sign 26). In the illustrated embodiment, the first front wall portion 158 is parallel to the rear wall portion 34 and perpendicular to the top wall portion 150. Likewise, the second front portion 162 is parallel to the rear wall portion 34 and perpendicular to the bottom wall portion 154.

With continued reference to FIG. 7, the ledge 86 extends from the bottom wall portion 154 and the groove 82 is coupled to the top wall portion 150, opposite the ledge 86. In the illustrated embodiment, the ledge 86 is co-planar with the bottom wall portion 154. The first groove 120 of the rail 118 is coupled to the rear wall portion 34 and the second groove 124 of the rail 118 is coupled to the first front wall portion 158. In the illustrated embodiment, the wall portion 94 to which the fasteners 90 are secured is the same as the second front wall portion 162. The rear wall portion 34, the top wall portion 150, the front wall portions 158, 162, and the bottom wall portion 154 at least partially define the interior chamber 66 of the raceway 18.

To assemble the sign assembly 10, a length of extruded aluminum raceway 18 is formed and cut to a desired length. The sign 26 is mounted to the face plate 22 by the fasteners 42. For example, the face plate 22 can be turret punched (or other suitable process) to form apertures (e.g., aperture 46) to facilitate coupling of the sign 26 to the face plate 22 and to allow the electrical connection 50 to connect between the electrical driver 114 and the sign 26. The face plate 22 is attached to the raceway 18 but inserting the first end 74 into the groove 82 and then securing the second end 78 to wall portion 94 with fasteners 90. Either before or after the face plate 22 is secured to the raceway 18, the tray 110 is inserted into the rail 118. The electrical driver 114 is electrically connected to the sign 26 and the electrical power source that is at least positioned at least partially within the high voltage chamber 132. The covers 98, 102 are then fastened to the axial ends 128 of the raceway 18 by a plurality of fasteners. The assembled illuminated sign assembly 10 is then mounted to the desired location (e.g., mount surface 14). A plurality of fasteners or other suitable fastening assembly can be used to couple the raceway 18 to the desired location. In some embodiments, the raceway 18 is mounted to the desired location as an initial step (e.g., before the face plate 22 is secured to the raceway 18).

What is claimed is:

1. A sign assembly comprising:
a raceway;
a plate removably coupled to the raceway;
a sign coupled to the plate such that the sign and the plate are removable together from the raceway;
wherein an electrical connection extends through the plate to the sign.

2. The sign assembly of claim 1, wherein an end of the plate is received within a groove in the raceway.

3. The sign assembly of claim 2, wherein the end is a first end and a second end of the plate is seated on a ledge of the raceway.

4. The sign assembly of claim 1, wherein the sign includes a plurality of illuminated letters, wherein the electrical connection is one of a plurality of electrical connections that extend through the plate to the plurality of illuminated letters, and wherein the plate and the plurality of illuminated letters are removable together from the raceway.

5. The sign assembly of claim 1, wherein the raceway includes an opening and the plate at least partially blocks the opening.

6. The sign assembly of claim 1, wherein the raceway includes a first portion configured to mount to a surface, a second portion extending from the first portion, and a third portion extending from the first portion, the third portion is parallel to the second portion.

7. The sign assembly of claim 6, wherein the raceway includes a first front portion that extends from the second portion and a second front portion that extends from the third portion; wherein an opening is positioned between the first front portion and the second front portion.

8. The sign assembly of claim 1, wherein the raceway includes a rail configured to support a tray, and wherein the tray supports an electrical component.

9. The sign assembly of claim 8, further including a divider positioned within the raceway, the divider at least partially defining a high voltage chamber.

10. A sign assembly comprising:
a body defining a chamber and an opening;
a plate removably coupled to the body, wherein the plate at least partially blocks the opening when the plate is coupled to the body; and
a sign coupled to the plate such that the sign and the plate are removable together from the body.

11. The sign assembly of claim 10, further including a power supply positioned within the chamber; wherein the sign is electrically connected the power supply.

12. The sign assembly of claim 11, wherein the sign includes a light emitting diode.

13. The sign assembly of claim 10, further including
a tray positioned within the chamber;
a power supply supported on the tray.

14. The sign assembly of claim 13, wherein an electrical connection extends between the power supply and the sign, the electrical connection is at least partially positioned within the chamber.

15. The sign assembly of claim 14, wherein the electrical connection is coupled to a guide that extends into the chamber.

16. The sign assembly of claim 13, further including a cover removably coupled to an axial end of the body, wherein removal of the cover from the body provides access to the power supply.

17. A raceway configured to mount to a surface, the raceway comprising:
a rear portion;
a top portion extending from the rear portion;
a bottom portion extending from the rear portion;
a first front portion extending from the top portion;
a second front portion extending from the bottom portion;
an opening positioned between the first front portion and second front portion;
a ledge extending from the bottom portion; and
a groove coupled to the top portion, the groove is positioned opposite the ledge and the opening is positioned between the groove and the ledge.

18. The raceway of claim 17, wherein the ledge is co-planar with the bottom portion.

19. The raceway of claim 17, further including a rail configured to support tray.

20. The raceway of claim 17, wherein the raceway is an extruded material.
